(19) United States
(12) Patent Application Publication
(10) Pub. No.: US 2015/0244205 A1
(43) Pub. Date: Aug. 27, 2015

(54) Energy Supply

(71) Applicant: Vega Grieshaber KG, Wolfach (DE)

(72) Inventors: Volker Allgaier, Haslach i. K. (DE); Andreas Isenmann, Haslach i. K. (DE)

(21) Appl. No.: 14/423,866

(22) PCT Filed: Oct. 10, 2013
(86) PCT No.: PCT/EP2013/071201

§ 371 Date: Feb. 25, 2015

(30) Foreign Application Priority Data
Oct. 10, 2012 (EP) 12188056.1

(51) Int. Cl. H02J 7/35; H02J 7/00

(52) U.S. Cl. CPC H02J 7/35; H02J 7/0052

(57) ABSTRACT

The invention is an energy supply for a field device that can be operated at a normal voltage, comprising the first energy supply having variable output voltage for the field device, an energy store, which can be charged by means of a charging circuit, which is arranged between the first energy supply and the energy store, wherein a first state, in which the output voltage is above a predetermined value, the charging circuit is switched in such a way that the field device is operated by means of the first energy supply and the energy store is charged, and in a second state, in which the output voltage is below the predetermined value, the charging circuit is switched in such a way that the field device is supplied by means of the first energy supply and the energy store.

### CROSS REFERENCE TO RELATED APPLICATIONS

This patent application claims priority to International Patent Application PCT/EP2013/071201, filed Oct. 10, 2013, and thereby to European Patent Application 12 188 056.1, filed on Oct. 10, 2012.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

Not applicable.

### SEQUENCE LISTING INCLUDED AND INCORPORATED BY REFERENCE HEREIN

Not applicable.

### BACKGROUND

1. Field of the Invention

The present invention relates to an energy supply.

2. Background of the Invention

The present invention is an energy supply for a field device to be operated with a nominal voltage.

Many such energy supplies for field devices are known from prior art, with a first energy supply unit being provided with a variable output voltage and an energy storage unit. The first energy supply unit feeds via a charging circuit the energy supply unit and this way charges it. The field device is then exclusively supplied from the energy supply unit.

FIG. 1 shows a block diagram of an energy supply unit known from prior art, in which an energy storage unit with a charging circuit 5 is arranged downstream in reference to a first energy supply unit 3. In the present exemplary embodiment the energy storage unit with the charging circuit 5 is designed as a battery 9 with a charging circuit embodied as an integrated circuit. For example a solar cell may be used as the first energy supply unit 3, which then via the charging circuit charges the battery 9. The battery 9 with the charging circuit is arranged downstream in reference to a field device 7, which is exclusively supplied with energy from the battery 9.

In energy supply units known from prior art it is considered disadvantageous that by the technically limited degree of effectiveness of the charging circuit as well as the energy storage inside the battery 9, both during the charging process of the battery 9 as well as during the supply of energy to the field device 7, energy is lost due to said degree of effectiveness. Furthermore, it is considered disadvantageous that an energy supply can occur exclusively via the battery 9 because, for example, situations may arise from the structural space available in which the circuitry known from prior art is impossible or at least disadvantageous.

The objective of the present invention is to provide an energy supply unit that overcomes the disadvantages known from prior art and ensures a more flexible as well as more energy efficient energy supply.

### BRIEF SUMMARY OF THE INVENTION

In a preferred embodiment, an energy supply unit (1) for a field device (7) that can be operated with a nominal voltage, comprising a first energy supply unit (3) with variable output voltage for the field device (7), an energy storage unit (9) which can be charged via a charging circuit (5) arranged between the first energy supply unit (3) and the energy storage unit (9), characterized in that the charging circuit (5) is switched in a first state, in which the output voltage is above a predetermined value, such that the field device (7) is operated via the first energy supply unit (3) and the energy storage unit (9) is charged, and the charging circuit (5) is switched in a second state, in which the output voltage is below the predetermined value, such that the field device (7) is supplied via the first energy supply unit (3) and the energy storage unit (9).

In another preferred embodiment, the energy supply unit (1) as described herein characterized in that the first energy supply unit (3) is a solar module.

In another preferred embodiment, the energy supply unit (1) as described herein, characterized in that the nominal voltage is the predetermined value.

In another preferred embodiment, the energy supply unit (1) as described herein, characterized in that the charging circuit (5) is embodied as an integrated circuit.

In another preferred embodiment, the energy supply unit (1) as described herein, characterized in that a comparator (11) is provided to switch from the first state into the second state, which compares a reference voltage (VRef) with a voltage proportional to the output voltage.

In another preferred embodiment, the energy supply unit (1) as described herein, characterized in that a voltage splitter is provided to generate voltage proportional to the output voltage.

In another preferred embodiment, the energy supply unit (1) as described herein, characterized in that a diode (D1, 2) is provided parallel in reference to the charging circuit (5), which is arranged such that it blocks in the first state and connects in the second state the energy storage unit (9) in a conductive fashion to the field device (7).

In another preferred embodiment, the energy supply unit (1) as described herein, characterized in that a second diode (D2) is provided between the energy supply unit (1) and the field device (7), which is arranged such that in the first state it connects the field device (7) and the charging circuit (5) in a conductive fashion to the energy supply unit (1) and blocks it in the second state.

### BRIEF DESCRIPTION OF THE DRAWINGS

FIG. 1 is a line drawing evidencing a block diagram of an energy supply unit of prior art (discussed herein above).

FIG. 2 is a line drawing evidencing a block diagram of an energy supply unit according to the invention.

FIG. 3 is a line drawing evidencing the energy supply unit of FIG. 2 in the first state.

FIG. 4 is a line drawing evidencing the energy supply unit of FIG. 2 in the second state.

FIG. 5 is a line drawing evidencing a diagram of a charging circuit as well as the energy storage unit.

### DETAILED DESCRIPTION OF THE INVENTION

An energy supply unit according to the invention for a field device that can be operated with a nominal voltage comprises a first energy supply unit with adjustable output voltage for the field device and an energy storage unit, which can be charged via a charging circuit arranged between the first energy supply unit and the energy storage unit. According to the invention, the charging circuit is switched in a first state, in which the output voltage exceeds a predetermined value such that the field device can be operated via the first energy supply unit and the energy storage unit is charged with surplus energy. In a second state, in which the output voltage is below a predetermined value, the charging circuit is switched such that the field device can be supplied via the first energy supply unit and the energy storage unit.

With the energy supply unit according to the invention it is ensured that the field device can be switched between the first voltage supply unit and the energy storage unit and thus any restrictions due to construction space, in which the use of the energy supply units of prior art is impossible, can be circumvented. Due to the fact that the field device is arranged between the voltage supply unit and the energy storage unit with the charging circuit, it is also possible that at any point of time at which an output voltage can be tapped at the first energy supply unit, the field device can be operated directly via said energy supply unit and if necessary the voltage difference remaining in reference to the nominal voltage of the field device can be provided by the energy storage unit. This way it is possible to directly use the energy provided by the first energy supply unit at almost every state without any loss at the charging circuit and the energy storage unit caused by the degree of effectiveness, and thus to provide an energy-saving energy supply.

The energy supply unit according to the invention can be used particularly beneficially when the first energy supply unit is embodied as a solar module. However, other energy supply units are also possible as the first energy supply unit, for example miniature windmills.

In particular, in first energy supply units subject to environmental fluctuations, the suggested circuitry is beneficial because on the one hand the generated renewable energy, for example, from the solar module or a miniature windmill, can be used directly and otherwise be stored. In the event that, for example, the solar module fails to provide any energy due to the weather or the time of day, here an operation of the field device is still ensured by the energy storage unit.

In those cases in which the first energy supply unit provides more energy than necessary for operating the field device, simultaneously the option is given to charge the energy storage unit in addition to operating the field device.

The suggested circuitry can also be particularly beneficially used when the pre-determined value for the output voltage is equivalent to the nominal voltage of the field device.

A particularly flexible, cost-effective and space-saving embodiment is yielded when the charging circuit is embodied as an integrated circuit. For example, FPGAs (Field Programmable Gate Arrays) may be used here, comprising microcontrollers programmed with appropriate algorithms or specially designed integrated circuits. Additionally, there is the option to adjust commercially available integrated charging circuits by an exterior circuitry to the energy supply unit according to the invention.

In order to switch the charging circuit from the first state into the second state and vice versa it is advantageous for a comparator to be provided which compares a reference voltage to a voltage proportional to the output voltage. The reference voltage may here be provided, for example, by the energy storage unit. The charging circuit may also use this signal for controlling the operating point of a solar cell.

In order to release the energy storage unit from the necessity to provide a reference voltage equivalent to the nominal voltage of the field device it may be beneficial to provide a voltage splitter to generate a voltage proportional to the output voltage. This way it is possible to operate the comparator with a considerably lower reference voltage and still set the switching time based on the nominal voltage of the field device.

In order to allow an energy flow from the energy storage unit to the field device and simultaneously to exclude energy flow into the energy storage unit by circumventing the charging circuit it is beneficial when parallel to the charging circuit a diode or other suitable components (e.g. MOSFET) are provided and arranged such that they block in the first state and in the second state connect the energy storage unit to the field device in a conductive fashion.

The diode is therefore connected with its anode to the positive terminal of the energy storage unit and with its cathode to the field device. When the energy supply of the field device is provided by the energy storage unit the diode is switched in the direction of flow and thus allows the energy flow from the energy storage unit to the field device.

In order to additionally prevent any energy flow in the direction of the first energy supply unit, it is beneficial to provide a second diode between the first energy supply unit and the field device, which is arranged such that in the first state it connects the field device and the charging circuit in a conductive fashion to the energy supply unit and blocks it in the second state.

When the output voltage provided by the first energy supply unit is lower than the nominal voltage of the field device and thus the field device is additionally supplied by the energy storage unit, higher voltage is supplied to the field device than to the first energy supply unit so that the second diode is blocking. The second diode is therefore with its anode connected to the first energy supply unit and with its cathode to the field device.

In order to avoid any oscillation of the suggested circuitry it is beneficial to provide the charging circuit and/or the comparator arranged upstream in reference to the charging circuit with sufficient hysteresis, so that any permanent switching of the charging circuit back and forth is avoided.

### DETAILED DESCRIPTION OF THE FIGURES

FIG. 1 evidences a block diagram of an energy supply unit of prior art (discussed herein above).

FIG. 2 shows a block diagram of an energy supply unit according to the invention. According to the block diagram a field device 7 is switched between a first energy supply unit 3 and another block, which comprises a charging circuit 5 as well as an energy storage unit 9. In general, energy flow is possible unidirectional from the first energy supply unit 3 to the field device 7 and bidirectional between the field device 7 and the block with the charging circuit 5 and the energy storage unit 9.

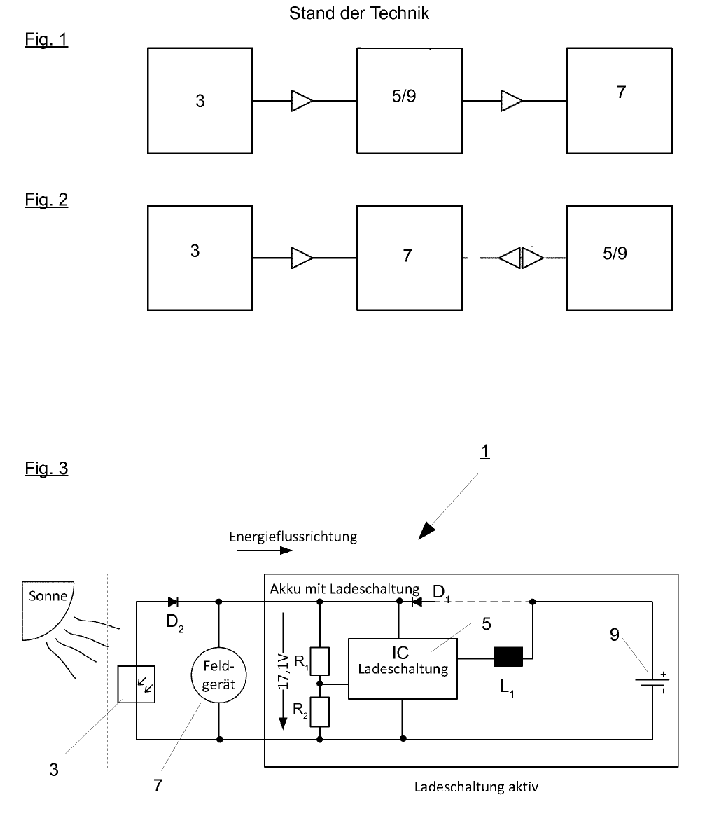

FIG. 3 shows the energy supply unit of FIG. 2 in a first state, with the individual components of the blocks shown in FIG. 2 being illustrated. The individual components are framed to illustrate the respective blocks as shown in FIG. 2.

A solar cell is provided as the first energy supply unit 3, which provides an output voltage when impinged with solar radiation. A second diode D2 is switched in the direction of flow between the solar cell 3 and the field device 7, which prevents that energy flows back out of the field device 7 into the solar cell 3. The second diode D2 interrupts any current flow from the field device 7 in the direction to the solar cell 3. The solar cell 3 and the field device 7 are connected to each other via their ground connections. In the present exemplary embodiment the charging circuit 5 with the energy storage unit is switched parallel in reference to the field device 7 between the ground connection and a supply connection of the field device 7.

In the present exemplary embodiment the charging circuit 5 is embodied as an integrated circuit and connected with a voltage splitter, which is also switched between the supply connection and the ground connection. A voltage, proportional to the voltage applied at the field device 7, is generated by the voltage splitter, which comprises a first resistor R1 and a second resistor R2 with an interposed tap site and said voltage is supplied to the charging circuit 5.

In the present exemplary embodiment a battery is provided as the energy storage unit 9. This battery 9 is connected with its negative terminal to the common ground connection and with its positive terminal to the charging circuit 5 and via a first diode D1 to the supply connection of the field device 7. Additionally, a coil L1 is arranged between the charging circuit 5 and the battery 9.

FIG. 3 shows the circuit arrangement in a first state, in which the solar cell 3 provides sufficient energy for the operation of the field device 7 as well as additional energy for charging the battery 9. In this state the second diode D2 is in a conductive state and energy flows from the solar cell 3 to the field device 7 as well as via the supply line to the charging circuit 5 and via the charging circuit 5 to the battery 9. The diode D1 is, however, in a blocking state so that energy flow from the solar cell 3 to the battery 9 is exclusively possible via the charging circuit 5. The diode D1 is not conductive in this state, because a higher voltage is applied at the side of the field device 7 than at the side of the battery 9.

The charging circuit 5 is activated in the first state and charges the battery 9.

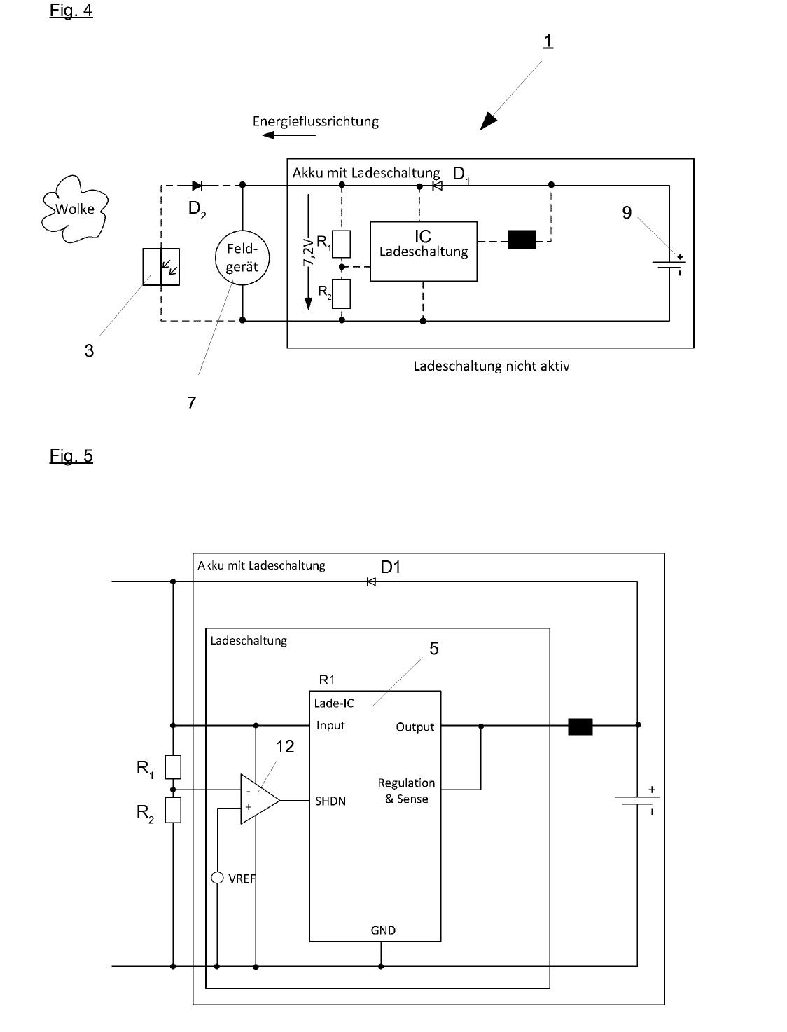

FIG. 4 shows the energy supply unit 1 of FIGS. 2 and 3 in a second state. In this second state the solar cell 3 provides energy insufficient for supplying the field device 7 so that any operation of the field device 7 is only possible with an additional energy supply from the battery 9. In this state the first diode D1 is in a conductive state, because a higher voltage is applied at the sides of the battery 9 than at the side of the field device 7, so that any energy flow from the battery 9 to the field device 7 is possible. The battery circuit 5 is deactivated in this state.

FIG. 5 shows an enlarged illustration of the charging circuit, with additionally the input circuit of the charging circuit 5 being shown.

A voltage proportional to the output voltage of the solar cell 3 is generated by the voltage splitter formed by the resistors R1 and R2, which is supplied to an inverting input of a comparator 11. A reference voltage is applied at the non-inverting input of the comparator 11, which may be provided by the battery 9, for example.

An output signal of the comparator 11 serves as the reference signal which indicates if the output voltage of the solar cell 3 is above or below the nominal voltage of the field device 7.

The comparator 11 may be equipped with a suitable hysteresis so that the output signal of the comparator 11 is prevented from surging in the event of voltage fluctuations about the nominal voltage of the field device 7 and thus any oscillation of the charging circuit is avoided. The output signal of the comparator 11 is supplied to an activation input of an integrated charging circuit, which activates or deactivates the charging circuit depending on the output signal of the comparator.

When the output voltage of the solar cell 3 is above the nominal voltage of the field device 7, the charging circuit 5 is activated and the battery 9 is charged. When the output voltage of the solar cell 3 is below the nominal voltage of the field device 7, the charging circuit 5 is deactivated and the field device 7 is supplied via the diode D1 with energy from the battery 9.

### List of Reference Numbers

1 energy supply unit
3 first energy supply unit
5 charging circuit

07 field device
9 energy storage unit/battery
12 comparator
D1 first diode
D2 second diode
R1 first resistor
R2 second resistor
L1 coil
VRef reference voltage

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable equivalents.

We claim:

1. An energy supply unit for a field device that can be operated with a nominal voltage, comprising a first energy supply with variable output voltage for the field device, an energy storage unit which can be charged via a charging circuit arranged between the first energy supply unit and the energy storage unit, wherein the charging circuit is switched in a first state, in which the output voltage is above a predetermined value, such that the field device is operated via the first energy supply unit and the energy storage unit is charged, and the charging circuit is switched in a second state, in which the output voltage is below the predetermined value, such that the field device is supplied via the first energy supply unit and the energy storage unit.

2. The energy supply unit of claim 1, wherein the first energy supply unit is a solar module.

3. The energy supply unit of claim 1, wherein the nominal voltage is the predetermined value.

4. The energy supply unit of claim 1, wherein the charging circuit is embodied as an integrated circuit.

5. The energy supply unit of claim 1, further comprising wherein a comparator is provided to switch from the first state into the second state, which compares a reference voltage with a voltage proportional to the output voltage.

6. The energy supply unit of claim 5, further comprising wherein a voltage splitter is provided to generate voltage proportional to the output voltage.

7. The energy supply unit of claim 1, further comprising wherein a diode is provided parallel in reference to the charging circuit, which is arranged such that it blocks in the first state and connects in the second state the energy storage unit in a conductive fashion to the field device.

8. The energy supply unit of claim 1, further comprising wherein a second diode is provided between the energy supply unit and the field device, which is arranged such that in the first state it connects the field device and the charging circuit in a conductive fashion to the energy supply unit and blocks it in the second state.
